(19) United States
(12) Patent Application Publication
(10) Pub. No.: US 2011/0029653 A1
(43) Pub. Date: Feb. 3, 2011

(54) NETMANAGER AND NETMODULE GENERAL UPNP EXTENSIONS FOR OCAP HNEXT

(75) Inventor: Robert C. Stein, Coopersburg, PA (US)

Correspondence Address: Motorola, Inc.;Patent Operations Law Department, 600 North US Highway 45, IL93-W2-55BB, Libertyville, IL, 60048-5343, US

(73) Assignee: GENERAL INSTRUMENT CORPORATION, Horsham, PA (US)

(21) Appl. No.: 12/849,565

(22) Filed: Aug. 3, 2010

Related U.S. Application Data
(60) Provisional application No. 61/231,001, filed on Aug. 3, 2009.

(51) Int. Cl. G06F 15/173

(52) U.S. Cl. 709/223

(57) ABSTRACT

A computer-implemented method for a home network registers an application with a NetManager, and provides a handler to the NetManager to control discovery of desired devices or services for the application. In one aspect of the present invention, the home network is an OpenCable Application Platform home network, and the desired devices or services are Universal Plug and Play devices or services. The method receives an event notification from the NetManager when the NetManager discovers a device or service that is one of the desired devices or services, creates an object instance of NetModule for the device or service, and accesses a standard interface for the device or service through the object instance of NetModule. The method accesses the standard interface by posting an XML document to the device or service using an interface of the object instance of NetModule.

### RELATED APPLICATION

This application for letters patent relates to and claims the benefit of U.S. Provisional Patent Application Ser. No. 61/231,001 (Attorney's docket number BCS05036), titled “NetManager and NetModule General UPnP Extensions for OCAP HNEXT”, and filed on Aug. 3, 2009; the disclosure of which this application hereby incorporates by reference.

### BACKGROUND

OpenCable is a set of hardware and software specifications under development in the United States by Cable Television Laboratories, Inc. (CableLabs) to define the next-generation digital consumer device for the cable television industry. OpenCable uses the Society of Cable Telecommunications Engineers (SCTE) standards for the video, transport and various interface requirements, but also adds a requirement for a Java based software interpreter to support the OpenCable Application Platform (OCAP) software environment (i.e., middleware).

The OCAP Home Networking (HN) Extensions (HNEXT) provide OCAP home networking applications with access to digital entertainment content available on devices connected to a cable service subscriber's home network. The OCAP HNEXT Application Program Interfaces (APIs) assume that the home network applications support functionality such as advertisement and discovery of connected devices. However, the OCAP HNEXT specification severely constrains the type of network access available to applications. Even though OCAP HNEXT uses standard Universal Plug and Play (UPnP) to discover devices on the home network, and to identify the services offered by the devices, such devices and services are limited to those defined by the UPnP Audio/Visual Profile (UPnP AN), and in particular the Media Server (MS) and Media Renderer (MR) devices and their associated services, such as the Content Directory Service (CDS) and Scheduled Recording Service (SRS).

There is a demand for a method and system to allow an application in an OCAP home network to discover other devices and services on the home network. The presently disclosed invention satisfies this demand.

### SUMMARY

Aspects of the present invention provide a computer-implemented method for a home network that registers an application with a NetManager, and provides a handler to the NetManager to control discovery of desired devices or services for the application. In one aspect of the present invention, the home network is an OpenCable Application Platform home network, and the desired devices or services are Universal Plug and Play devices or services. The method receives an event notification from the NetManager when the NetManager discovers a device or service that is one of the desired devices or services, creates an object instance of NetModule for the device or service, and accesses a standard interface for the device or service through the object instance of NetModule. The method accesses the standard interface by posting an XML document to the device or service using an interface of the object instance of NetModule.

### BRIEF DESCRIPTION OF THE DRAWINGS

FIG. 1 is a network diagram that illustrates one embodiment of the hardware components of a system that performs the present invention.

FIG. 2 is a block diagram that illustrates, in detail, one embodiment of the hardware components shown in FIG. 1.

FIG. 3 is a block diagram that illustrates an organization of the OCAP HN stack according to the prior art.

FIG. 4 is a block diagram that illustrates an organization of the OCAP HN stack according to one embodiment of the present invention.

FIG. 5 is a flow diagram that illustrates a method to allow an application in an OCAP home network to discover other devices and services on the home network according to one embodiment of the present invention.

### DETAILED DESCRIPTION

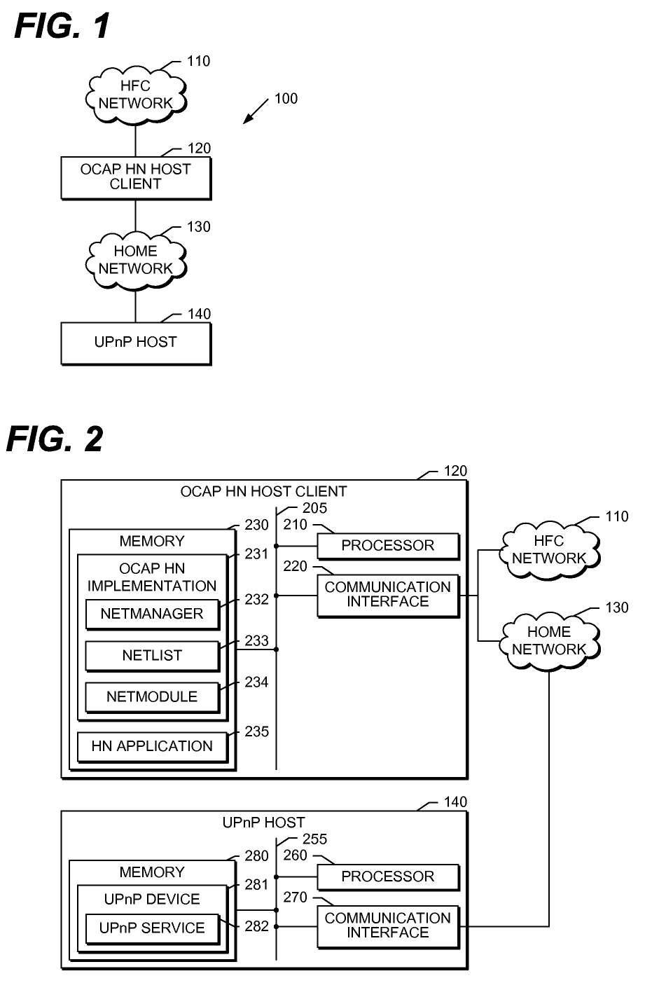

FIG. 1 is a network diagram that illustrates one embodiment of the hardware components of a system that performs the present invention. A home networking system 100 includes a hybrid fiber-coaxial (HFC) network 110, OCAP HN host client 120, home network 130, and UPnP host 140. The OCAP HN host client 120 connects to the HFC network 110, and the home network 130. The UPnP host 140 connects to the home network 130. The OCAP HN host client 120 receives data and video content from the HFC network 110 and distributes the data and video content to the UPnP host 140 via the home network 130. In various embodiments, the OCAP HN host client 120 is a set-top box connected to a video display device, personal computer, printer, and wireless access point connected to a wireless device such as a laptop, personal digital assistant, telephone, or the like. The home networking system 100 shown in FIG. 1 may include any number of interconnected HFC networks 110, OCAP HN host clients 120, home networks 130, and UPnP hosts 140.

The HFC network 110 shown in FIG. 1, in one embodiment, is a broadband network that combines optical fiber and coaxial cable, technology commonly employed globally by cable television operators since the early 1990s. The fiber optic network extends from the cable operators master head end, sometimes to regional head ends, and out to a neighborhood hubsite, and finally to a fiber optic node that serves anywhere from 25 to 2000 homes. The master head end will usually have satellite dishes for reception of distant video signals as well as IP aggregation routers. Some master head ends also house telephony equipment for providing telecommunications services to the community. The regional head ends receive the video signal from the master head end and add to it the Public, Educational and/or Governmental (PEG) channels as required by local franchising authorities or insert targeted advertising that would appeal to the region. The various services are encoded, modulated and up-converted onto RF carriers, combined onto a single electrical signal and inserted into a broadband optical transmitter. This optical transmitter converts the electrical signal to a downstream optically modulated signal that is sent to the nodes. Fiber optic cables connect the head end to optical nodes in a point-to-point or star topology, or in some cases, in a protected ring topology.

The home network 130 shown in FIG. 1, in one embodiment, is a private communication network. The present invention also contemplates the use of comparable network architectures. Comparable network architectures include a LAN, a Personal Area Network (PAN) such as a Bluetooth network, a wireless LAN (e.g., a Wireless-Fidelity (Wi-Fi) network), and a Virtual Private Network (VPN). The system also contemplates network architectures and protocols such as Ethernet, Internet Protocol, and Transmission Control Protocol.

FIG. 2 is a block diagram that illustrates, in detail, one embodiment of the hardware components shown in FIG. 1. In particular, FIG. 2 illustrates the hardware components and software comprising the OCAP HN host client 120 and UPnP host 140 shown in FIG. 1.

The OCAP HN host client 120, in one embodiment, comprises a general-purpose computing device that performs the present invention. A bus 205 is a communication medium that connects a processor 210, communication interface 220, and memory 230 (such as Random Access Memory (RAM), Dynamic RAM (DRAM), non-volatile computer memory, flash memory, or the like). The processor 210, in one embodiment, is a central processing unit (CPU). The communication interface 220 connects the OCAP HN host client 120 to the HFC network 110 and home network 130. In one embodiment, the implementation of the OCAP HN host client 120 is an application-specific integrated circuit (ASIC). In another embodiment, the OCAP HN host client 120 includes a data storage device (not shown), such as a Serial ATA (SATA) hard disk drive, optical drive, Small Computer System Interface (SCSI) disk, flash memory, or the like.

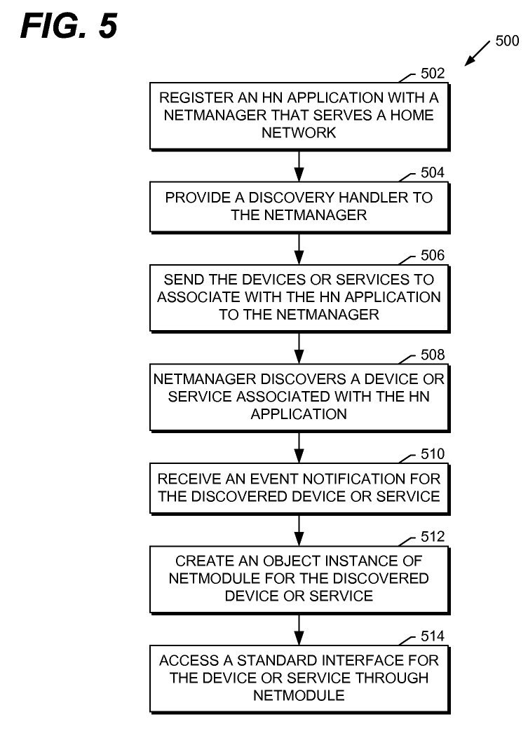

The processor 210 performs the disclosed methods by executing the sequences of operational instructions that comprise each computer program resident in, or operative on, the memory 230. The reader should understand that the memory 230 may include operating system, administrative, and database programs that support the programs disclosed in this application. In one embodiment, the configuration of the memory 230 of the OCAP HN host client 120 includes an OCAP HN implementation 231, and an HN application 235. The OCAP HN implementation 231 includes a NetManager 232 interface, NetList 233, and NetModule 234 interface. The OCAP HN implementation 231, NetManager 232 interface, NetList 233, NetModule 234 interface, and HN application 235 perform the methods of the present invention disclosed in detail in FIG. 4 and FIG. 5. When the processor 210 performs the disclosed methods, it stores intermediate results in the memory 230 or a data storage device (not shown). In another embodiment, the memory 230 may swap these programs, or portions thereof, in and out of the memory 230 as needed, and thus may include fewer than all of these programs at any one time.

The UPnP host 140, in one embodiment, comprises a general-purpose computing device that offers services discovered and used by the OCAP HN host client 120 which perform the methods of the present invention. A bus 255 is a communication medium that connects a processor 260, communication interface 270, and memory 280 (such as Random Access Memory (RAM), Dynamic RAM (DRAM), non-volatile computer memory, flash memory, or the like). The processor 260, in one embodiment, is a central processing unit (CPU). The communication interface 270 connects the UPnP host 140 to the home network 130. In one embodiment, the implementation of the UPnP host 140 is an application-specific integrated circuit (ASIC). In another embodiment, the UPnP host 140 includes a data storage device (not shown), such as a Serial ATA (SATA) hard disk drive, optical drive, Small Computer System Interface (SCSI) disk, flash memory, or the like.

The processor 260 offers services discovered and used by the OCAP HN host client 120 which perform the disclosed methods by executing the sequences of operational instructions that comprise each computer program resident in, or operative on, the memory 280. The reader should understand that the memory 280 may include operating system, administrative, and database programs that support the programs disclosed in this application. In one embodiment, the configuration of the memory 280 of the UPnP host 140 includes a UPnP device 281. The UPnP device 281 includes a UPnP service 282. The UPnP device 281 and UPnP service 282, in one embodiment, offers services discovered and used by the OCAP HN host client 120 which perform the methods of the present invention disclosed in detail in FIG. 4 and FIG. 5. When the processor 260 performs the disclosed methods, it stores intermediate results in the memory 280 or a data storage device (not shown). In another embodiment, the memory 280 may swap these programs, or portions thereof, in and out of the memory 280 as needed, and thus may include fewer than all of these programs at any one time.

The OCAP HN implementation 231 provides support for the NetModule 234 interface. The NetModule 234 interface is an abstraction of functionality that is provided by the Device interface, where each instance of the Device interface is a device on the home network 130. NetManager 232 is a singleton class that registers every Device and NetModule 234 within the home network 130. NetManager 232 performs UPnP discovery to locate UPnP devices on the home network 130, and the sub-devices that these devices support. In one embodiment, and as currently defined by OCAP, NetManager 232 only attempts to discover devices that support the UPnP Media Server (MS) and Media Renderer (MR) devices, and their associated services, particularly the Content Directory Service (CDS) and the Scheduled Recording Service (SRS). For each UPnP host 140 that NetManager 232 discovers, it creates an object instance of Device. For each CDS that NetManager 232 discovers, it creates an object instance of NetModule 234 and contains it in the OCAP HN host client 120. NetManager 232 sets properties based on the capabilities discovered for the CDS, including CONTENT_SERVER, CONTENT_LIST, and CONTENT_MANAGER. If the OCAP HN host client 120 also hosts an SRS, NetManager 232 may also set properties related to recording, such as CONTENT_{—} RECORDER.

The NetModule 234 interface defines the field properties (1) CONTENT_LIST; (2) CONTENT_MANAGER; (3) CONTENT_SERVER; (4) CONTENT_RECORDER; and (5) CONTENT_RENDERER. In one embodiment, the first four of these field properties map to the UPnP AN MS device, and the field property maps to an MR device. The OpenCable Home Networking Protocol 2.0 specification (see http://www.cablelabs.com/specifications/OC-SP-HNP2.0-I03-100603.pdf) provides additional information on this mapping. NetModule 234 defines additional properties that applications are not likely to use, but that are valuable to the defined sub-interfaces for NetModule 234, or perhaps to implementing classes. These properties correspond to the standard UPnP interfaces that a device will use to interact with UPnP services, namely, (1) PROP_CONTROL_URL, the target of control action requests; (2) PROP_DESCRIPTION_URL, the target of requests for retrieving device and service descriptions; and (3) PROP_EventSub_URL, the target of event subscriptions requests. The sub-interfaces defined for NetModule 234 also deal only with the CDS and SRS service mappings.

The OCAP HN implementation 231 also provides support for the ContentServerNetModule, ContentManagementNetModule, NetRecordingRequestManager, and RecordingNetModule interfaces. The ContentServerNetModule and ContentManagementNetModule interfaces map to CDS actions, while the NetRecordingRequestManager and RecordingNetModule interfaces map to SRS actions. These interfaces are further supported by the ContentContainer and ContentEntry interfaces and their sub-interfaces.

However, the OCAP HN implementation 231 does not allow applications to discover, or use, other devices and services, such as UPnP devices and services, that may be on the home network 130. The present invention defines a method and system to allow the HN application 235 to request that the NetManager 232 interface on the OCAP HN implementation 231 use basic UPnP device and service discovery to look for additional, application-specified services on the home network 130, and to add the application-defined NetModule 234 types to those defined by the OCAP HNEXT specification.

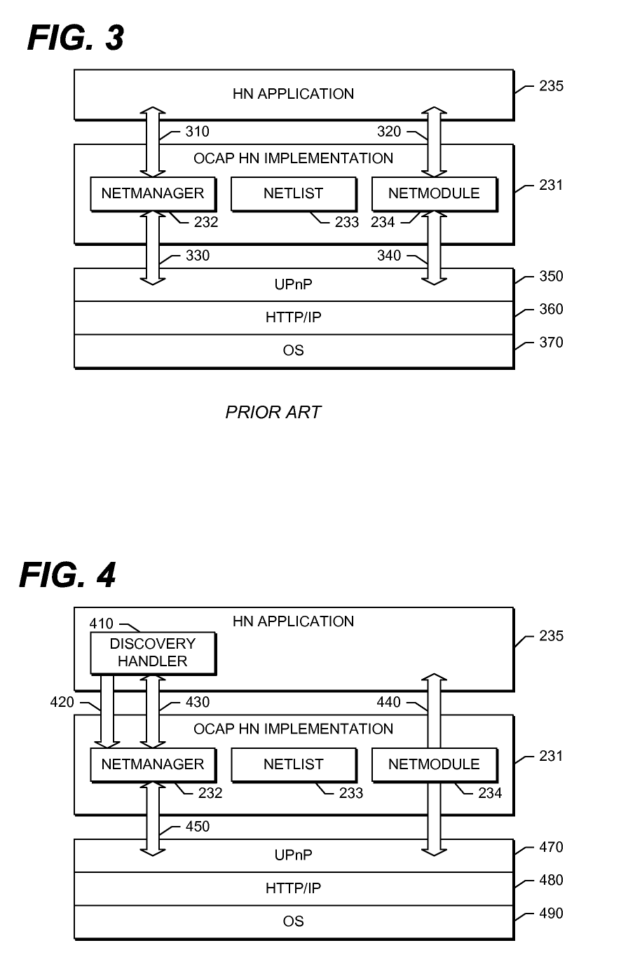

Because a concrete object that implements the NetModule 234 interface may also implement its sub-interfaces, the HN application 235 can expect that a NetModule 234 object with the CONTENT_SERVER property can be accessed through the ContentServerNetModule sub-interface. NetManager 232 collects all of the UPnP host 140 and NetModule 234 instances in a NetList 233 that can be retrieved and filtered by the HN application 281. To do its job, NetManager 232 relies on an implementation-dependent UPnP stack. In the API for the OCAP HN implementation 231, there is no access to these “lower-level” code interfaces by applications. This provides a measure of control to prevent applications from performing network actions not otherwise authorized by the cable network operator. FIG. 3 illustrates an organization of the OCAP HN stack to implement this functionality.

FIG. 3 is a block diagram that illustrates an organization of the OCAP HN stack according to the prior art. As shown in FIG. 3, the HN application 235 communicates with OCAP HN implementation 231 via the NetManager 232 and NetModule 234 interfaces. The communication between the HN application 235 and the OCAP HN implementation 231 (communication path 310 and 320) only allow the HN application 235 to use the ContentServerNetModule, ContentManagementNetModule, RecordingNetModule, and NetRecordingRequestManager interfaces. The NetManager 232 interface of the OCAP HN implementation 231 communicates with the UPnP 350 to perform UPnP discovery (communication path 330). The NetModule 234 interface of the OCAP HN implementation 231 communicates with the UPnP 350 to perform UPnP interactions with the UPnP 350 interface (communication path 340).

FIG. 4 is a block diagram that illustrates an organization of the OCAP HN stack according to one embodiment of the present invention. The present invention allows the HN application 281, with sufficient permissions, to register new types of NetModule 234 interfaces with the NetManager 232 interface. The HN application 235, via the discovery handler 410, communicates registration information (communication path 420) with the NetManager 232 to instruct NetManager 232 how to discover the desired devices and services, and also to provide a general NetModule 234 sub-interface that allows the HN application 235 to interact with UPnP devices and services such as the UPnP host 140. This general NetModule 234 sub-interface exposes the UPnP discovery and interaction interfaces otherwise inaccessible to the HN application 235 in a controlled manner.

Because the OCAP HN implementation 231 does not support these new devices/services directly, the HN application 235 is responsible for implementing the discovery and implementation details. Accordingly, the registration method (communication path 420) requires that the HN application 235, via the discovery handler 410, provide the NetManager 232 with instructions as to how to discover devices and services sought by the HN application 235. Also, the HN application 235 provides the discovery handler 410 to the NetManager 232 as the mechanism for receiving notifications of events 430 associated with discovery of the devices and services associated with (i.e., desired by) the HN application 235. Thus, the invention provides access to the UPnP 470 machinery of the OCAP HN implementation 231, but does so in a defined manner that can be controlled by the cable system operator.

When NetManager 232 discovers a device or service registered by the HN application 235 (communication path 450), the NetManager 232 calls the discovery handler 410 supplied by the HN application 235 (communication path 430) to allow the HN application 235 to create an object instance of NetModule 234 of the desired class. The class that implements this NetModule 234 can implement a sub-interface appropriate for the desired device type. The object instance is passed back to NetManager 232 to be added to the NetList 233 of devices and services. This makes the discovered devices and services available to any application that understands the device and service definitions and which has appropriate permissions.

The general UPnP NetModule 234 interface allows the HN application 235 to directly post requests to the UPnP 470 standard interfaces (control, description, event subscription) (communication path 440). The requests are passed in the form of the eXtensible Markup Language (XML) documents that ordinarily would be sent to the UPnP URLs provided by the UPnP device/service. Formulating these requests for the added NetModule 234 types is a responsibility of the HN application 235. These new methods, as with all methods that generate network actions in the OCAP HN implementation 231, require that the HN application 235 to provide a NetActionHandler that is called by the OCAP HN implementation 231 when the response is received, with a NetActionEvent parameter. When the HN application 235 calls the standard NetActionEvent.getResponse() method, it receives the full XML document response returned by the device or service.

NetManager 232 is an abstract class as defined in OCAP HN implementation 231. To implement the present invention, the interface is extended by adding a new method for registration of new NetModule 234 types by HN applications 235, for example, addNetModuleType. This method is accessible only by HN applications 235 with sufficient permission, and attempts to call this method without permissions causes the implementation to throw an exception. The parameters for this method describe a) the device or service to discover; b) a discovery handler method to be called when responses to discovery are received. The parameter passed in to the discovery handler method provides the XML response to discovery provided by the device/service. The return from the discovery handler method is an instance of NetModule 234 when the method is successful, and null otherwise.

The invention defines a new sub-interface of NetModule 234 that is called UpnpNetModule. This interface and its methods are accessible only by applications with sufficient permission, and attempts to call this method without permissions causes the implementation to throw an exception. The methods of UpnpNetModule allow the application to interact directly with the UPnP service:

The requestControl() method passes the argument XML document to the UPnP 470 device/service by posting the document to the PROP_CONTROL_URL property of the underlying NetModule 234. This method also requires a parameter NetActionHandler that receives the response to the request.

The requestDescription() method passes the argument XML document to the UPnP 470 device/service by posting the document to the PROP_DESCRIPTION_URL property of the underlying NetModule 234. This method also requires a parameter NetActionHandler that receives the response to the request.

The requestEvent() method passes the argument XML document to the UPnP 470 device/service by posting the document to the PROP_EventSub_URL property of the underlying NetModule 234. This method also requires a parameter NetActionHandler that receives the response to the request, and this method also requires a parameter NetActionHandler that receives events for the requested subscription.

FIG. 5 is a flow diagram that illustrates a method according to one embodiment of the present invention. In particular, FIG. 5, with reference to FIG. 1, FIG. 2, and FIG. 4, illustrates a method to allow an application in an OCAP home network to discover other devices and services on the home network.

The process 500 shown in FIG. 5 begins when an HN application 235 registers with a NetManager 232 that serves an OCAP home network (step 502). The HN application 235 provides a discovery handler 410 (step 504), and a list of the devices and services to associate with the HN application 235 (i.e., desired devices and services) (step 506) to the NetManager 232. When the NetManager 232 discovers one of the devices or services associated with the HN application 235 (step 508), the HN application 235, via the discovery handler 410, receives an event notification for the discovered device or service (step 510). The HN application 235 creates an object instance of NetModule 234 for the discovered device or service (step 512). The HN application 235 is then allowed to access a standard interface for the device or service through NetModule 234 (step 514). The access to the standard interface for the device or service includes requesting to retrieve a description for the device or service, requesting to subscribe to the device or service for event notifications, and requesting for the device or service to perform a service action request.

Although the disclosed embodiments describe a fully functioning method and system for allowing an application in an OCAP home network to access a standard interface for a Universal Plug and Play device or service discovered on the OCAP home network, the reader should understand that other equivalent embodiments exist. Since numerous modifications and variations will occur to those reviewing this disclosure, the method and system for allowing an application in an OCAP home network to access a standard interface for a Universal Plug and Play device or service discovered on the OCAP home network is not limited to the exact construction and operation illustrated and disclosed. Accordingly, this disclosure intends all suitable modifications and equivalents to fall within the scope of the claims.

I claim:

1. A computer-implemented method, comprising:
registering an application with a NetManager that serves a home network;
providing a handler to the NetManager, wherein the handler controls discovery of desired devices or services for the application;
receiving an event notification from the NetManager when the NetManager discovers a device or service that is one of the desired devices or services;
creating an object instance of NetModule for the device or service; and
accessing a standard interface for the device or service through the object instance of NetModule.

2. The computer-implemented method of claim 1, wherein the registering of the application further comprises:
sending a request to register the application to the NetManager; and
receiving a response from the NetManager, the response including an indication of a successful registration.

3. The computer-implemented method of claim 1, wherein the providing of the handler further comprises:
sending a reference to the handler to the NetManager; and
sending the desired devices or services to the NetManager.

4. The computer-implemented method of claim 1, wherein the home network is an OpenCable Application Platform (OCAP) home network, and wherein the desired devices or services are Universal Plug and Play (UPnP) devices or services.

5. The computer-implemented method of claim 1, wherein the creating of the object instance further comprises:
sending a request to the NetManager to add the object instance of NetModule to a NetList associated with the NetManager.

6. The computer-implemented method of claim 1, wherein the accessing of the standard interface further comprises:
posting an XML document to the device or service using an interface of the object instance of NetModule,
wherein the XML document represents a request to retrieve a description for the device or service.

7. The computer-implemented method of claim 1, wherein the accessing of the standard interface further comprises:
posting an XML document to the device or service using an interface of the object instance of NetModule,
wherein the XML document represents a request to subscribe to the device or service for event notifications.

8. The computer-implemented method of claim 1, wherein the accessing of the standard interface further comprises:
posting an XML document to the device or service using an interface of the object instance of NetModule,
wherein the XML document represents a request for the device or service to perform a service action request.

9. An object-based computing system, comprising:
a memory device resident in the computing device; and
a processor disposed in communication with the memory device, the processor configured to:
register an application with a NetManager that serves a home network;
provide a handler to the NetManager, wherein the handler controls discovery of desired devices or services for the application;
receive an event notification from the NetManager when the NetManager discovers a device or service that is one of the desired devices or services;
create an object instance of NetModule for the device or service; and
access a standard interface for the device or service through the object instance of NetModule.

10. The object-based computing system of claim 9, wherein to register the application, the processor is further configured to:
send a request to register the application to the NetManager; and
receive a response from the NetManager, the response including an indication of a successful registration.

11. The object-based computing system of claim 9, wherein to provide the handler, the processor is further configured to:
send a reference to the handler to the NetManager; and
send the desired devices or services to the NetManager.

12. The object-based computing system of claim 9, wherein the home network is an OpenCable Application Platform (OCAP) home network, and wherein the desired devices or services are Universal Plug and Play (UPnP) devices or services.

13. The object-based computing system of claim 9, wherein to create the object instance, the processor is further configured to:
send a request to the NetManager to add the object instance of NetModule to a NetList associated with the NetManager.

14. The object-based computing system of claim 9, wherein to access the standard interface, the processor is further configured to:
post an XML document to the device or service using an interface of the object instance of NetModule,
wherein the XML document represents a request to retrieve a description for the device or service.

15. The object-based computing system of claim 9, wherein to access the standard interface, the processor is further configured to:
post an XML document to the device or service using an interface of the object instance of NetModule,
wherein the XML document represents a request to subscribe to the device or service for event notifications.

16. The object-based computing system of claim 9, wherein to access the standard interface, the processor is further configured to:
post an XML document to the device or service using an interface of the object instance of NetModule,
wherein the XML document represents a request for the device or service to perform a service action request.

17. A non-transitory computer-readable medium, comprising computer-executable instructions that, when executed on a computing device, perform steps of:
registering an application with a NetManager that serves a home network;
providing a handler to the NetManager, wherein the handler controls discovery of desired devices or services for the application;
receiving an event notification from the NetManager when the NetManager discovers a device or service that is one of the desired devices or services;
creating an object instance of NetModule for the device or service; and accessing a standard interface for the device or service through the object instance of NetModule.

18. The non-transitory computer-readable medium of claim 17, wherein the registering of the application further comprises:
sending a request to register the application to the NetManager; and
receiving a response from the NetManager, the response including an indication of a successful registration.

19. The non-transitory computer-readable medium of claim 17, wherein the providing of the handler further comprises:
sending a reference to the handler to the NetManager; and
sending the desired devices or services to the NetManager.

20. The non-transitory computer-readable medium of claim 17, wherein the home network is an OpenCable Application Platform (OCAP) home network, and wherein the desired devices or services are Universal Plug and Play (UPnP) devices or services.

21. The non-transitory computer-readable medium of claim 17, wherein the creating of the object instance further comprises:
sending a request to the NetManager to add the object instance of NetModule to a NetList associated with the NetManager.

22. The non-transitory computer-readable medium of claim 17, wherein the accessing of the standard interface further comprises:
posting an XML document to the device or service using an interface of the object instance of NetModule,
wherein the XML document represents a request to retrieve a description for the device or service.

23. The non-transitory computer-readable medium of claim 17, wherein the accessing of the standard interface further comprises:
posting an XML document to the device or service using an interface of the object instance of NetModule,
wherein the XML document represents a request to subscribe to the device or service for event notifications.

24. The non-transitory computer-readable medium of claim 17, wherein the accessing of the standard interface further comprises:
posting an XML document to the device or service using an interface of the object instance of NetModule,
wherein the XML document represents a request for the device or service to perform a service action request.
